(19) United States
(12) Patent Application Publication
(10) Pub. No.: US 2008/0107313 A1
(43) Pub. Date: May 8, 2008

(54) Methods and Apparatus to Facilitate Picture Archiving

(76) Inventor: Paul Joseph O'Dea, Muskego, WI (US)

Correspondence Address: Thomas M. Fisher;Fisher Patent Group LLC, 700 6th Street NW, Hickory, NC, 28601, US

(21) Appl. No.: 11/557,175

(22) Filed: Nov. 7, 2006

(51) Int. Cl. G06K 9/00

(52) U.S. Cl. 382/128

(57) ABSTRACT

A method includes providing a software core module, which is configured to communicate over a network using at least three different standards, directly providing the software core module on a first diagnostic imaging machine of a first size, and directly providing the software core module on a second diagnostic imaging machine of any size different than the first size.

### BACKGROUND OF THE INVENTION

This invention relates generally to diagnostic imaging methods and apparatus, and more particularly, to methods and apparatus that provide for facilitating picture archiving.

The following three definitions are used herein:

1. Picture archiving and communications system (PACS): A system that acquires, transmits, stores, retrieves, and displays digital images and related patient information from at least one imaging source and communicates the information over a network.

2. Health Level-7 Data Communications Protocol (HL7): Defines standards for transmitting: billing information, hospital census information, order entries, and other health-related information. Health Level Seven (HL7), Inc., is a non-profit standards developing organization and is accredited by the American National Standards Institute (ANSI).

3. Integrating Healthcare Enterprise (IHE): IHE is an initiative by healthcare professionals and industry to improve the way computer systems in healthcare share information. IHE promotes the coordinated use of established standards such as DICOM (Digital Imaging and Communication in Medicine) and HL7 to address specific clinical needs in support of optimal patient care.

Traditionally medical devices have communicated with PACS systems using standard protocols. The PACS systems are then responsible for a variety of tasks that include archiving, image conversion, and transmission of images and patient information to other systems. In some cases, the PACS systems also have some workstation capabilities which may include image display and manipulation or those functions may be done on a separate workstation.

Support for the HL7 protocol by medical devices is sporadic. Additionally, the current PACS implementations are believed to be less than optimal at dealing with anticipated larger file sizes in the future, the use of multiple file formats, and the performance of raw data compression, while maintaining the ability to process an image after the initial acquisition.

### BRIEF DESCRIPTION OF THE INVENTION

In one aspect, a method includes providing a software core module, which is configured to communicate over a network using at least three different standards. The method also includes directly providing the software core module on a first diagnostic imaging machine of a first size, and directly providing the software core module on a second diagnostic imaging machine of any size different than the first size.

In another aspect, a method is provided that includes providing a picture archiving and communication system (PACS) that is itself an imaging source.

In yet another aspect, apparatus includes a device configured to employ PACS functionality and directly receive imaging data from a detector.

In yet still another aspect, a computer readable medium is embedded with a program configured to instruct a computer to directly receive imaging data from a detector and for the computer to provide PACS functionality.

### BRIEF DESCRIPTION OF THE DRAWINGS

FIG. 1 illustrates a prior art configuration.

FIG. 2 illustrates a configuration in which devices include embedded PACS functionality.

FIG. 3 illustrates the current modality data management software architecture.

FIG. 4 illustrates an embedded PACS architecture including an embedded PACS imaging device communicating integrally with a PACS system, an IHE system, and a HL7 system.

FIG. 5 illustrates that, in one embodiment, a method includes providing a picture archiving and communication system (PACS) that is itself an imaging source.

### DETAILED DESCRIPTION OF THE INVENTION

There are herein described methods and apparatus useful for imaging systems such as, for example, but not limited to, an ultrasound system. Such figures are intended to be illustrative rather than limiting and are included herewith to facilitate explanation of an exemplary embodiment of the apparatus and methods of the invention. Although, described in the setting of an ultrasound system, it is contemplated that the benefits of the invention accrue to all diagnostic imaging systems and modalities such as PET, MRI, SPECT, Ultrasound, fused systems such as a CT/PET system, and/or any modality yet to be developed in which the imaging system can include embedded PACS functionality. The phrase “PACS functionality” means, as used herein, the ability to acquire, transmit, store, retrieve, and display digital images and related patient information, and communicate the digital images and related patient information over a network. Additionally, the herein described embedded PACS implementations are believed to be well suited at dealing with anticipated larger file sizes in the future, the use of multiple file formats, and the performance of raw data compression, while maintaining the ability to process an image after the initial acquisition.

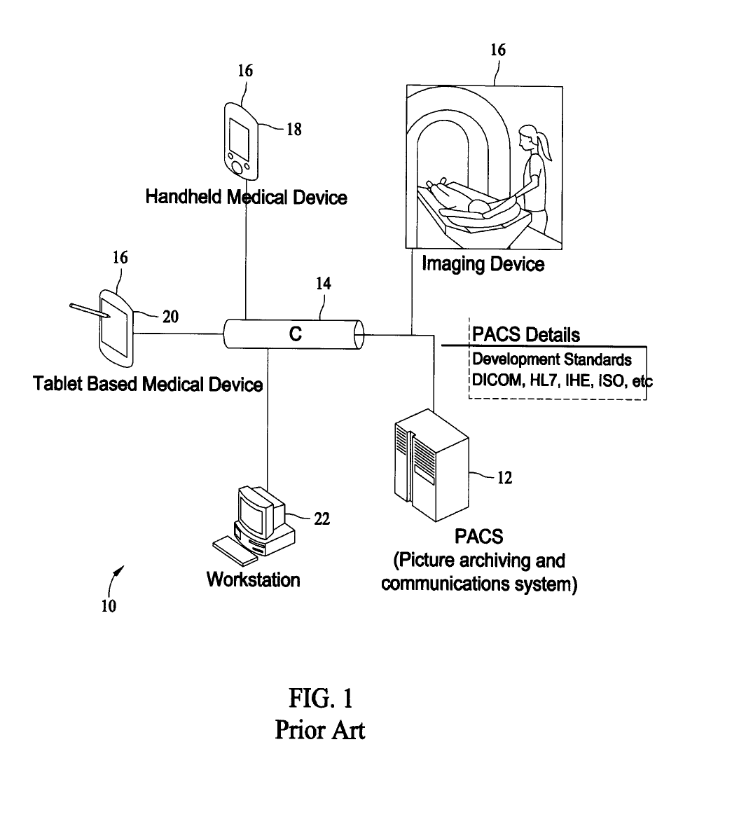

FIG. 1 illustrates a prior art configuration 10. More specifically, FIG. 1 illustrates a traditional PACS 12 (picture archiving and communications system) connected to a network 14, such as the Internet, to which one or more imaging devices 16 may be connected. The actual imaging source such as any ultrasound detector, a CT detector, or a PET detector that is connectable through the Internet, as are handheld medical devices 18, tablet-based medical devices 20, and workstations 22. As used herein the terms imaging system, imaging machine, diagnostic imaging machine, and imaging source are used interchangeably and are meant to refer to any imaging device that collects energy either transmitted through an object (as in CT) or collects energy emitted from the object (as in PET). And as used herein “energy transmitted through an object” is meant to include Ultrasound (where the energy is typically only partially transmitted through the object before being reflected back) and to include MRI where energy is first transmitted to the object and then a receiver or antenna receives energy from the object. As used herein the term “detector” refers to any device that initially collects the received energy.

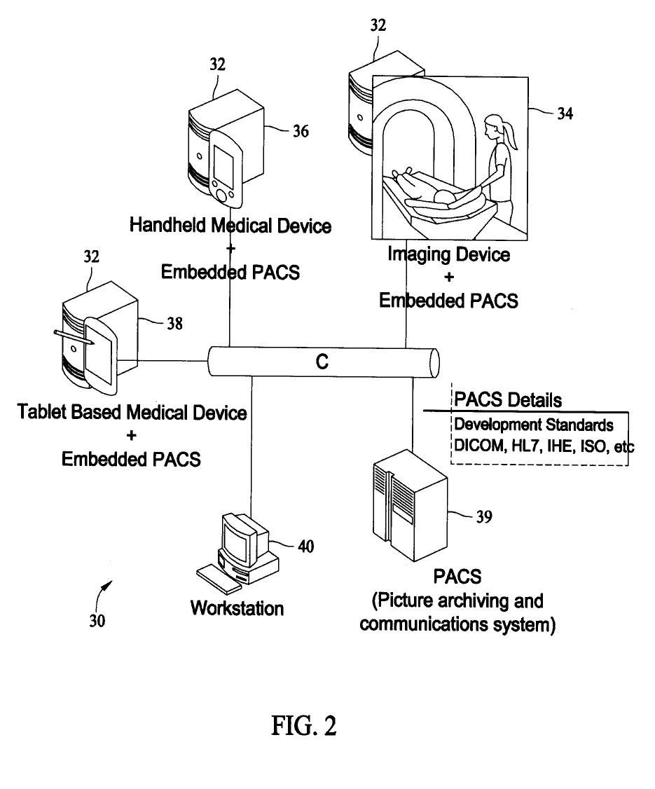

FIG. 2 illustrates a configuration 30 in which devices 32 include embedded PACS functionality. The tablet-based medical device 38 includes embedded PACS functionality, a handheld medical device 36 includes embedded PACS functionality, as does the imaging source 34. As shown in FIG. 2, and in accordance with one embodiment, the new configuration 30 includes a PACS 39 that is identical to PACS 12 shown in FIG. 1. Thusly created is an embedded scalable PACS/Workstation 40. The deployment of this software would be directly on the medical device. The deployment could take on several form factors depending upon the individual requirements of the device. Some of the possible form factors may include a single board computer plugged directly into the device, a chip with the software burned in and mounted inside of a smaller device, and even the software itself could be directly deployed on the medical device. This allows the user of the device to perform functions which have been previously unavailable, such as image review, image measuring, and/or image manipulation.

With connectivity of medical devices increasing in general, (for example, wireless, Bluetooth, etc.) it is conceivable that all devices could have the capability of performing PACS/Workstation functions. Traditionally, the Ultrasound Modality (could be any and all modalities) has communicated with PACS to transmit and receive images and information. As the healthcare systems become increasingly more connected, the functionality desired at the Ultrasound Scanner (or more generally; any modality, handheld medical devices, and point of care devices) increases. It would be desirable for the functionality at the Ultrasound Scanner to increase to become more like a PACS/HL7 device. This functionality is common across the medical devices listed previously. It is therefore desirable to provide this functionality in a form that can be used by the Ultrasound Scanner in such a manner that the system is independent of the modality/device on which it is used (in any medical device). To that end, a software system is proposed that can be scaled to match the needs of the Ultrasound Scanner (device). Such a system will provide the following: 1) Traditional DICOM connectivity will be provided to the PACS systems. 2) The ability to view and manipulate images will be provided. 3) HL7 protocol support to the HL7 systems will be provided, including support for Electronic Health Records (EHR). 4) Support for IHE will be provided. 5) The capability to embed a software solution onto a single computer board, or a chip is herein provided. 6) Also, the ability to scale the support for functionality and protocol support is provided. 7) The ability to send measurement data to HL7 devices will be provided. 8) The ability to use Electronic Health Records (EHR)/Electronic Medical Records (EMR) will be provided.

The system provides support for the DICOM 3.0 protocol. The system provides image viewing and workstation functionality at the modality/medical device. The system provides scalability of support. 1) The deployed system may be configured so that no HL7 support is provided. 2) The system maybe be configured so that no DICOM support is provided. 3) The system may be configured so that images may be viewed but not manipulated like a workstation. 4) The system may be configured so no support for electronic records is provided. And instead of no support the system may be configured for partial support such that some fields of the electronic records are supported while other fields are unsupported. 5) The system may be configured so no support for providing measurement data to HL7. Request by HL7 devices for measurement data could be satisfied directly by the device embedding such a system. 6) The system may have combinations of the previous five example scaling.

The need for modalities to provide functionality from the traditional PACS, HL7 and IHE domains continues. To meet this need an embeddable scalable solution is desired to provide the functionality required to meet the needs of an increasingly connected healthcare organization. The herein described methods and apparatus provide a software scalable PACS/HL7/IHE system. This will provide any medical device the ability to exchange information, and view information from the set of devices which comprise the hospital enterprise. For example, in one embodiment, a method includes providing a software core module, which is configured to communicate over a network using at least three different standards, directly providing the software core module on a first diagnostic imaging machine of a first size, and directly providing the software core module on a second diagnostic imaging machine of any size different than the first size. By size, it is contemplated both physical size and memory size. A device with more memory could have more modules than just the core module that would go on a device with less memory.

The herein described methods and apparatus will provide the desired information at the point of care. That point of care can be a traditional medical modality, and/or a hand held device used by a doctor or technician. The herein described methods and apparatus would also provide data such as measurements to devices that support only the HL7 protocol. The system would be provided as a pure software only solution or as a software-hardware solution.

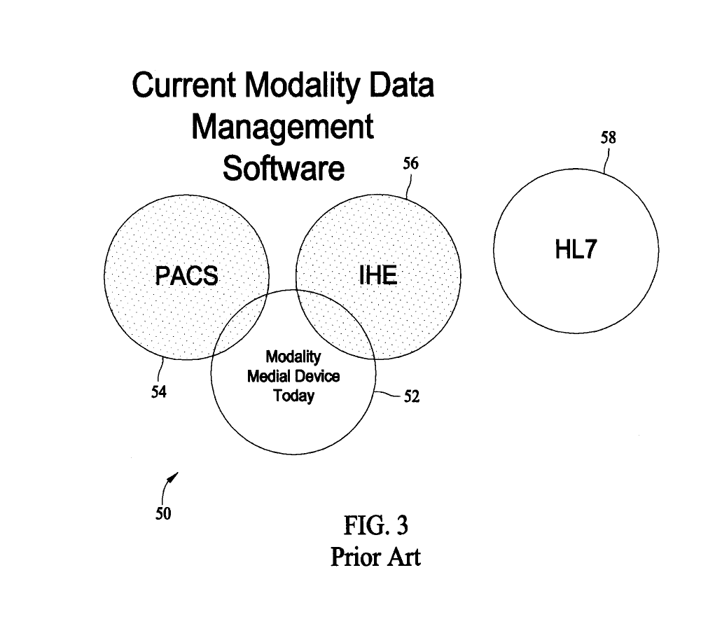

FIG. 3 illustrates the current modality data management software architecture 50, wherein the medical device 52 typically communicates separately to a PACS system 54, an IHE system 56, and typically has no communication with an HL7 system 58. In other words, medical device 52 is not programmed with the HL7 protocol.

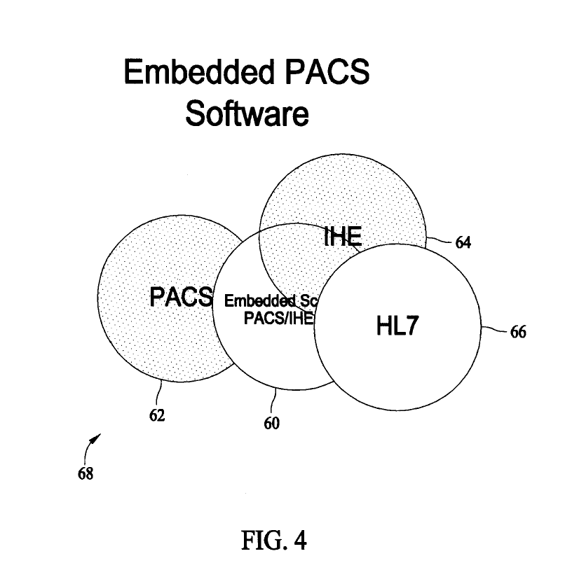

FIG. 4 illustrates an embedded PACS architecture 68 including an embedded PACS imaging device 60 communicating integrally with a PACS system 62, an IHE system 64, and a HL7 system 66.

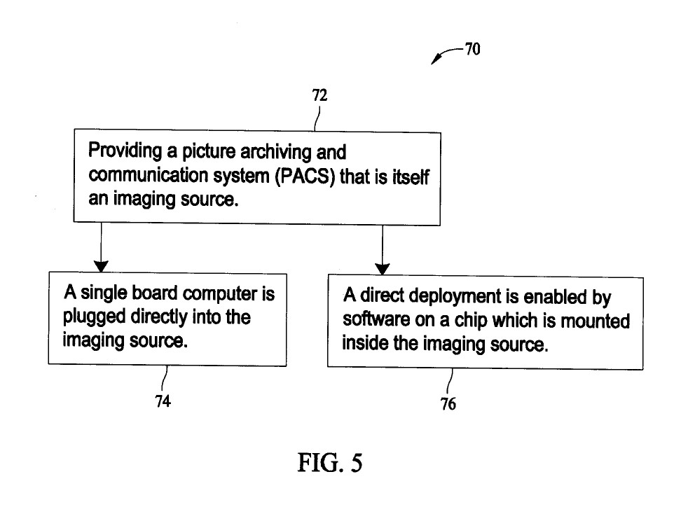

FIG. 5 illustrates that one embodiment, a method 70 includes providing a picture archiving and communication system (PACS) that is itself an imaging source 72. In one embodiment method 70 is implemented via a single board computer, which is plugged directly into the imaging source at step 74. Alternatively, another direct deployment could be enabled by a chip, which is mounted inside the imaging source at step 76.

In one embodiment, the imaging system is an ultrasound system configured as described herein. The ultrasound imaging system includes a processing circuit. The processing circuit (e.g., a microcontroller, microprocessor, custom ASIC, or the like) is coupled to a memory and a display device. The memory (e.g., including one or more of a floppy disk drive, CD-ROM drive, DVD drive, magnetic optical disk (MOD) device, or any other digital device including a network connecting device such as an Ethernet device for reading instructions and/or data from a computer-readable medium, such as a floppy disk, or an other digital source such as a network or the Internet, as well as yet to be developed digital means, and the like) stores imaging data.

The memory may also store a computer program including instructions executed by the processing circuit to implement the functions described herein. The processing circuit provides an image for display on a device. The detector may be a flat panel solid state image detector, for example, although conventional film images (in an x-ray implementation) stored in digital form in the memory may also be processed. In one embodiment, the processing circuit executes instructions stored in firmware (not shown).

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

In different embodiments, technical effects include that the herein described methods and apparatus provide for taking a fully functional system and scaling it to fit the device. Today, many devices provide the pieces of the functionality desired to interact in the hospital environment. One advantage of the herein described methods and apparatus is that it takes a fully functional system and scales it to fit the device. This provides standard functionality and allows the devices to provide the user more capabilities.

Exemplary embodiments are described above in detail. The assemblies and methods are not limited to the specific embodiments described herein, but rather, components of each assembly and/or method may be utilized independently and separately from other components described herein.

It is contemplated that those skilled in the art would recognize that the invention can be practiced with modification(s) within the spirit and scope of the claims.

What is claimed is:

1. A method comprising:
providing a software core module, which is configured to communicate over a network using at least three different standards;
directly providing the software core module on a first diagnostic imaging machine of a first size; and
directly providing the software core module on a second diagnostic imaging machine of any size different than the first size.

2. A method comprising providing a picture archiving and communication system (PACS) that is itself an imaging source.

3. A method in accordance with claim 2 wherein the imaging source is an ultrasound system configured to allow a user to measure an image.

4. A method in accordance with claim 2 wherein the imaging source is a CT system configured to allow a user to measure an image.

5. A method in accordance with claim 2 wherein the imaging source is a PET system configured to allow a user to measure an image.

6. A method in accordance with claim 2 wherein the imaging source is a MRI system configured to allow a user to measure an image.

7. A method in accordance with claim 2 wherein to accomplish the PACS system itself being an imaging source, a single board computer is plugged directly into the imaging source.

8. A method in accordance with claim 2 wherein the PACS system is scalable.

9. A method in accordance with claim 2 wherein to accomplish the PACS system itself being an imaging source, software is directly deployed on the medical device to enable the PACS functionality.

10. A method in accordance with claim 9 wherein the direct deployment is enabled by software on a chip which is mounted inside the imaging source.

11. Apparatus comprising a device configured to employ PACS functionality and directly receive imaging data from a detector.

12. Apparatus in accordance with claim 11 wherein said detector is an ultrasound detector and said device allows a user to manipulate an image.

13. Apparatus in accordance with claim 11 wherein said detector is a CT detector and said device allows a user to manipulate an image.

14. Apparatus in accordance with claim 11 wherein said detector is a PET detector and said device allows a user to manipulate an image.

15. Apparatus in accordance with claim 11 wherein said detector is a MRI detector and said device allows a user to manipulate an image.

16. Apparatus in accordance with claim 11 wherein said device comprises an imaging source and a single board computer attached to said imaging source.

17. Apparatus in accordance with claim 11 wherein said device comprises an imaging source with embedded software that provides PACS functionality.

18. A computer readable medium embedded with a program configured to instruct a computer to directly receive imaging data from a detector and for the computer to provide PACS functionality.

19. A medium in accordance with claim 18 wherein the program is on a single board computer attached to an imaging source.

20. A medium in accordance with claim 18 wherein said medium is embedded in a chip inside an imaging source.
